(19) United States
(12) Patent Application Publication
(10) Pub. No.: US 2026/0359809 A1
(43) Pub. Date: Nov. 12, 2026

(54) DEVICE FOR ENCRYPTING PRIVATE KEYS/SEED PHRASES OF CRYPTO ASSET WALLETS AND STORING ON NFC CHIPS AND METHOD FOR THE DEVICE

(71) Applicant: Cristóbal Javier ROSA MORALES, Arcozelo (PT)

(72) Inventor: Cristóbal Javier ROSA MORALES, Arcozelo (PT)

(21) Appl. No.: 19/137,647

(22) PCT Filed: Apr. 11, 2023
(86) PCT No.: PCT/ES2023/070231

§ 371 Date: Jun. 11, 2025

(30) Foreign Application Priority Data
Dec. 21, 2022 (ES) P202231090

(51) Int. Cl. G06Q 20/36; G06F 21/60; G06Q 20/32; H04L 9/32

(52) U.S. Cl. CPC G06Q 20/3674; G06F 21/602; G06Q 20/3278; H04L 9/3231

(57) ABSTRACT

The invention relates to a device (1) for encrypting private keys/seed phrases of crypto asset wallets and storing on NFC chips, which comprises:
a first microcontroller (2) with a first microprocessor (20) with an embedded operating system, a memory (22) for operation and for firmware storage, and interfaces (23) with the rest of the elements of the device;
a secure hardware element (21) with a second microcontroller (21a) with a second microprocessor (21b) and firmware, physically separate from the first microcontroller (2) and first microprocessor (20), for generating cryptograms and managing any sensitive data item of the process;
a screen (5);
a keyboard (6);
biometric-variable readers (7); and
and wherein the secure hardware element (21) comprises a secure memory (21c), separate from the memory (22) for general operation.
   The invention also includes a method for this device.

### OBJECT OF THE INVENTION

The present invention relates to a device for encryption of private keys/seed phrases of crypto asset wallets and storage in NFC chips, and to a method for this device.

### BACKGROUND OF THE INVENTION

To protect certain crypto assets, such as cryptocurrencies, their use is restricted by means of private keys.

Although so-called cold storage hardware wallets exist, and their corresponding encryption algorithms, all these systems always generate the so-called seed phrases or recovery words, so that in case of loss, theft, or identification of attack or vulnerability of the same, with these seed phrases generated by them, users can recover their crypto assets. The protection of these seed phrases/recovery words is not properly solved today, since the general rule is always to store them in plain form outside of any device with an Internet connection, whereby currently any user seeking to protect them safely opts to write them down on physical paper or engrave them on steel plates, without any greater protection than the physical concealment of these systems from third parties, therefore any third party with access to the paper or steel plates will have direct access to the crypto assets.

### DESCRIPTION OF THE INVENTION

The device for encryption of private keys/seed phrases of crypto asset wallets and storage on NFC chips of the invention comprises:
a first microcontroller, which comprises a first microprocessor with an embedded operating system for controlling peripherals, memories for operation and for firmware storage, and interfaces with the rest of the elements of the device,
a secure hardware element, which comprises a second microcontroller with a second microprocessor and firmware, physically separated from the first microcontroller and first microprocessor (which controls the different peripherals), designed exclusively for the functions of generating cryptograms and management of any sensitive data of the process,
a reader/writer of NFC chips,
a screen,
a keyboard (which can be physical or a virtual keyboard displayed on a touch screen),
biometric-variable readers (for example, fingerprint, iris, or vein structure readers), and
a power source.

The secure hardware element also comprises a secure memory, separated from the memory for general operation, to store high-security data.

For its part, the method of the invention comprises the steps of:
key encryption; comprising the following sub-steps:
   entering an encryption command through a physical or virtual keyboard,
   reading an NFC chip and verifying that it is a blank chip (that has no stored data), through an NFC chip reader/writer, and finishing the process if it is not a blank NFC chip and displaying this result on the screen,
   if the NFC chip is blank, displaying its unique identification code on the screen, so that the user can verify this code with the one printed on the chip itself,
   entering the key to be encrypted through the keyboard (it is preferred to use the BIPS-39 standard, proposing the seed words with only the first 4 letters),
   displaying on the screen, without the possibility of editing, the entered key-to avoid error/alteration due to interface handling; this way, the user can verify that the text/message to be encrypted is correct before proceeding to encrypt it- and validating the displayed key (by pressing continue, for example),
   displaying on the screen a message requesting a first password for encryption of the entered key,
   entering the password through the keyboard, generating a first cryptogram that contains the encrypted key (by means of the corresponding HASH or encryption algorithm), and temporarily storing the first cryptogram in the secure hardware element to be used in the next process,
   requesting biometric signature of the authorized person or persons to perform decryptions of the key, and entering the biometric signatures of these authorized persons through biometric-variable readers (fingerprint, iris, or vein structure),
   storing the biometric signatures in the secure hardware element,
   requesting the entry of a second password for encryption of the biometric variables, entering this second password through the keyboard, and generating a second cryptogram using an encryption algorithm, which contains at least:
      the first cryptogram,
      the biometric variables of those authorized,
      the authentication steps through biometric variables to allow the decryption of the first cryptogram,
      the HASH of the firmware version used in the encryption,
      the unique identification code of the NFC chip; and
   recording the second cryptogram on the blank NFC chip, after which all information is securely deleted from any memory of the device and/or the secure hardware element.

comprising a second key decryption step, which comprises the following sub-steps:
entering decryption command,
reading the NFC chip that contains the previously stored key/seed phrase to be decrypted,
displaying the unique identification code of the NFC chip on the screen,
confirming the download of the second cryptogram stored on the NFC chip to the secure hardware element,
requesting the entry of the second decryption password of the second cryptogram, and proceeding to enter it through keyboard,
if the entered second password is correct, decrypting the second cryptogram by extracting all its contents into the secure hardware element, and launching a biometric authentication process of the authorized persons by identifying their biometric variables using biometric-variable readers,
validating the entered biometric variables by comparing them with the biometric variables extracted from the second cryptogram,
if the entered biometric variables are correct, requesting the entry of the first password through the screen,
reading the first password entered by the authorized person, and if correct, decrypting the first cryptogram, displaying the private key/seed phrase on the screen for a limited time, and
once the key has been displayed on the screen for the limited time, deleting all information stored in memory and in the secure hardware element.

In this way, with the device of the invention and through the method of the invention, the technical effect of being able to encrypt highly sensitive information and also establish biometric access control to this encrypted information is achieved. It is also a technical-effect innovation that this already-encrypted information, and its biometric access configuration, can be stored on an NFC tag, from the same hardware device, and all of this without requiring a computer or external device and, above all, without an Internet connection, which minimizes intrusion risks.

Its configuration is very simple, yet suitable for encrypting, storing, and controlling access to seed phrases/private keys of crypto asset wallets, this specific use being of great utility in the market and a specific innovation in the cryptocurrency sector, Bitcoin, etc.

Furthermore, the invention has the following advantages:
By means of a single device, and without participation of a computer, cryptograms are created and stored with the highest security standards of current encryption.
It is capable of protecting data, encrypting secrets/crypto asset seed phrases/private keys (a plain text), generating in the process a cryptogram small enough to be stored in the memory of an NFC chip, and which can only be decrypted by knowing the symmetric passwords and overcoming biometric access control of the authorized persons, according to the multi-signature or single-signature configuration established in its original encryption, whether they be fingerprints, vein structure or iris, or a combination of several of them.

### BRIEF DESCRIPTION OF THE DRAWINGS

FIG. 1 shows a block diagram of the device of the invention.

FIG. 2 shows an exterior view of the device of the invention.

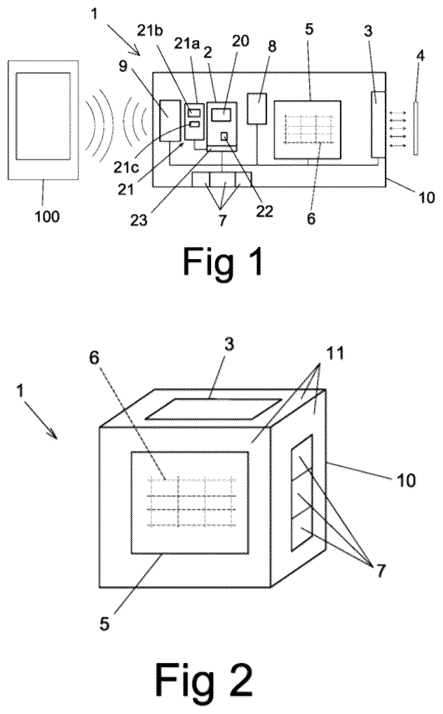

### DESCRIPTION OF A PRACTICAL EMBODIMENT OF THE INVENTION

The device (1) for encrypting private keys/seed phrases of crypto asset wallets and storing on NFC chips of the invention comprises:
a first microcontroller (2) that comprises a first microprocessor (20) with an embedded operating system, a memory (22) for operation and for firmware storage, and interfaces (23) with the rest of the elements of the device;
a secure hardware element (21), which comprises a second microcontroller (21a) with a second microprocessor (21b) and firmware, physically separated from the previous one (which controls the different peripherals), designed exclusively for the functions of generating cryptograms and management of any sensitive data of the process,
a reader/writer (3) of NFC chips (4);
a screen (5);
a keyboard (6); virtual and shown on a touch screen in this example,
biometric-variable readers (7) for fingerprints, iris, and vein structure in this example; and
a power source (8),

The secure hardware element also comprises a secure memory (21c), likewise separated from the general operating memory (22), which allows maximum security data to be stored in this area to hinder any physical intrusion during encryption processes.

In addition, it has been planned that the device firmware update will be carried out through a wireless link (9) (BT, Wi-Fi, . . . ) limited by asymmetric key exchange, fully encrypting the communication, and the update is subject to validation of the hash of the firmware to be updated, thereby preventing the installation of unauthorized firmware. This being the only valid external connection to link exclusively with a paired personal terminal (100) (for firmware updates only), so that it is guaranteed that the device will never connect to the Internet, as it will only be able to communicate for updates with the paired terminal.

The device (1) also comprises a closed housing (10) with flat surfaces (11) where the operating elements (keyboard/screen, NFC reader, etc.) are arranged, which facilitates handling.

The method of the invention comprises the following steps:
key encryption step, which comprises the following sub-steps:
   entering an encryption command through the keyboard (6), physical or virtual (displayed on the screen, which is touch-sensitive in this case),
   reading an NFC chip (4) and verifying that it is a blank chip, through an NFC chip reader/writer (3), ending the process if it is not a blank NFC chip (4) and displaying this result on the screen (5),
   if the NFC chip (4) is blank, displaying on the screen (5) its unique identification code, so that the user can verify this code with the one printed on the chip itself,
   entering the private key/seed phrase to be encrypted through the keyboard (6) using the BIPS-39 standard in a predictive manner with only the first 4 letters,
   displaying on the screen (5), without the possibility of editing, the entered key, and validating the displayed key,
   displaying on the screen (5) a message requesting a first password for encryption of the entered private key/seed phrase,
   entering the password through the keyboard (6) and generating a first cryptogram that contains the encrypted private key/seed phrase using an encryption algorithm, and temporarily storing the first cryptogram in the secure hardware element,
   requesting the biometric signature of the authorized person or persons to perform decryption of the private key/seed phrase (on the screen), and entering the biometric signatures of these authorized persons through the biometric variable readers (7) (for fingerprints, iris, or vein structure),
   storing the biometric signatures in the secure hardware element (21),
   requesting (on screen) the entry of a second password for encryption of the biometric variables, entering this second password through the keyboard (6), and generating a second cryptogram using an encryption algorithm, which contains at least:
      the first cryptogram,
      the biometric variables of those authorized,
      the authentication steps through biometric variables to allow the decryption of
      the first cryptogram,
      the HASH of the firmware version used in the encryption,
      the unique identification code of the NFC chip; and
   recording the second cryptogram on the blank NFC chip (4), after which all information is securely deleted from any memory of the device and/or the secure hardware element;

comprising a second key decryption step, which comprises the following sub-steps:
entering decryption command, through the keyboard (6)
reading the NFC chip (4) that contains the previously stored key/seed phrase to be decrypted,
displaying the unique identification code of the NFC chip on the screen (5) (and a message to verify that it is correct),
confirming (through the keyboard) the download of the second cryptogram stored on the NFC chip (if the ID is correct) to the secure hardware element,
requesting the entry of the second decryption password of the second cryptogram, and proceeding to enter it through the keyboard (6),
if the entered second password is correct, decrypting the second cryptogram by extracting all its contents into the secure hardware element (21), and launching a biometric authentication process of the authorized persons by identifying their biometric variables using biometric-variable readers (7),
validating the entered biometric variables by comparing them with the biometric variables extracted from the second cryptogram,
if the entered biometric variables are correct, requesting the entry of the first password through the screen (5),
reading the first password entered by the authorized person (through the keyboard (6)), and if it is correct, decrypting the first cryptogram, displaying the private key/seed phrase on the screen (5), for a limited time (for example 60 seconds, extendable upon confirmation request on screen), and
once the key has been displayed on the screen (5) for the limited time, securely deleting all information stored in any memory and in the secure hardware element.

It is preferred that the sub-steps of displaying the unique identification code of the NFC chip (4) on the screen (5) include displaying it in QR format, so that the user can read it with a smartphone application, verify the match, and save it in this app with an alias.

Likewise, it is preferred that the first password and/or the second password comprise a maximum of 40 characters and a minimum of 12, including numbers, uppercase, lowercase, and symbols, to achieve sufficient complexity, thus avoiding weaknesses in the password that could reduce the entropy of the resulting cryptogram.

Furthermore, the cryptogram encryption algorithm used will preferably be at least a symmetric algorithm such as AES 256 (or any superior one that may be implemented in the future), since currently there is no supercomputer on our planet capable of breaking this encryption system by brute force. Some studies estimate that today's most powerful current supercomputers would take several million years to do so.

According to the method of the invention, it is preferred that the sub-step of entering the biometric signature of the authorized person or persons to perform key decryptions comprises the entry of the biometric signature of a single person, or the entry of the biometric signatures of several persons, with a maximum of six persons, allowing decryption with all of them, or with five, four, three or two of them, or only one of them, depending on how it was configured in the original encryption. This allows the use of the key by different authorized persons, with the same security features, enforcing, if necessary, the presence of several people to access the encrypted private key/seed phrase.

In addition, it is preferred that the sub-step of entering the biometric signature of the authorized person or persons to perform key decryptions comprises the entry of:
up to four fingerprints per authorized person, and a minimum of two,
up to two iris configurations per authorized person; the entry of only one biometric data per person being sufficient to access the first cryptogram, which allows the use of several biometric validation possibilities in case any of them fail.

Ideally, the sub-step of recording the second cryptogram on the NFC chip (4) will comprise the following steps:
requesting (through the screen, for example) the user to bring the NFC chip (4) close to the NFC chip reader/writer (3),
verifying that the unique identification code of the NFC chip (4) is correct, proceeding with the recording in that case, and giving a warning otherwise, to avoid saving the second cryptogram on the wrong chip.

Also, it is preferred that the sub-step of recording the second cryptogram on the NFC chip (4) comprises a step of data deletion and restart of the process in the event of a second incorrect reading of the unique identification code of the NFC chip (4), forcing the user to start completely from the beginning.

Likewise, it is preferred that the sub-step of entering the second password comprises a step of data deletion and restart of the process in the event of a second incorrect entry of the same, forcing the user to start completely from the beginning; comprising the introduction of a temporary delay for enabling new attempts of action on the NFC chip (4) with that unique identification code.

The sub-step of validating the biometric variables entered with the biometric variables extracted from the second cryptogram will also comprise a step of data deletion and restart of the process in the event of any authentication failure; adding an access block to the first cryptogram stored in the secure hardware element (21) until a correct biometric reading is obtained solely from a biometric reader. This aims to establish an additional logic, with additional communication that certifies that there has been at least one biometric authentication, to allow access to the first cryptogram.

In the same way, the sub-step of decrypting the first cryptogram will comprise a step of data deletion and restart of the process in the event of incorrect entry of the first password.

The method of the invention additionally comprises a step of cloning the information stored on the NFC chip (4), which comprises the following sub-steps:
entering the cloning command through the keyboard (6),
requesting reading of the NFC chip (4) to be cloned, and displaying its unique identification code on the screen (5),
requesting the entry of the second password,
requesting biometric authentication of at least one of the authorized persons,
reading the requested biometric variables and, if they are correct, downloading the second cryptogram into the secure hardware element (21),
requesting the approach to the reader/writer (3) of a blank destination NFC chip (4), displaying its unique identification code on the screen (5),
requesting confirmation from the authorized person for cloning onto the blank NFC chip (4) whose unique identification code has been displayed on the screen, and proceeding with the copy of the second cryptogram onto the blank NFC chip (4), and
deletion of the second cryptogram from any memory and from the secure hardware element once the copy has been made.

In this case, the sub-step of entering the second password comprises a step of deleting data and restart of the process in case of incorrect entry for the second time.

Once the nature of the invention has been sufficiently described, as well as the way it is carried out in practice, it should be noted that the provisions previously indicated and represented in the attached drawings are susceptible to detailed modifications as long as they do not alter the fundamental principle.

1. Device (1) for encryption of private keys/seed phrases of crypto asset wallets and storage on NFC chips; characterized by comprising:
a first microcontroller (2), which comprises a first microprocessor (20) with embedded operating system, a memory (22) for operation and for firmware storage, and interfaces (23) with the rest of the elements of the device,
a secure hardware element (21), which comprises a second microcontroller (21a) with a second microprocessor (21b) and firmware physically separated from the first microcontroller (2) and first microprocessor (20), for generating cryptogram and managing any sensitive data of the process,
a reader/writer (3) of NFC chips (4),
a screen (5),
a keyboard (6),
biometric-variable readers (7), and
a power source (8); and
wherein the secure hardware element (21) comprises a secure memory (21c), separated from the memory (22) for general operation, to store high-security data.

2. Device (1) for encryption of private keys/seed phrases of crypto assets wallets and storage on NFC chips according to claim 1, comprising a wireless link (9) limited by asymmetric encryption and firmware Hash validation to link exclusively with a paired personal terminal (100), whose only supported process is the update of the device's own firmware.

3. Device (1) for encryption of private keys/seed phrases of crypto assets wallets and storage on NFC chips according to any of the preceding claims, comprising a closed housing (10) with flat surfaces (11) where the operating elements are arranged.

4. Method for encryption of private keys/seed phrases of crypto assets wallets and storage on NFC chips; characterized in that it comprises the steps of:
key encryption, comprising the following sub-steps:
entering an encryption command through the physical or virtual keyboard (6),
reading an NFC chip (4) and verifying that it is a blank chip, through an NFC chip reader/writer (3), ending the process if it is not a blank NFC chip (4) and displaying this result on the screen (5),
if the NFC chip (4) is blank, displaying on the screen (5) its unique identification code,
entering the private key/seed phrase to be encrypted through the keyboard (6),
displaying the entered key on the screen (5), without the possibility of editing, and validating the displayed key,
displaying a message on the screen (5) requesting a first password for encryption of the entered key,
entering the password through the keyboard (6) and generating a first cryptogram that contains the encrypted private key/seed phrase, and temporarily storing the first cryptogram in the secure hardware element (21),
requesting the biometric signature of the authorized person or persons to perform decryptions of the key, and entering the biometric signatures through the biometric-variable readers (7),
storing the biometric signatures in the secure hardware element (21),
requesting the entry of a second password for encryption of the biometric variables, entering this second password through the keyboard (6), and generating a second cryptogram using an encryption algorithm, which contains at least:
the first cryptogram,
the biometric variables of those authorized,
the authentication steps through biometric variables to allow the decryption of the first cryptogram,
the HASH of the firmware version used for the encryption,
the unique identification code of the NFC chip; and
recording the second cryptogram on the blank NFC chip (4), after which all information is securely deleted all information from any memory of the device and/or the secure hardware element.
comprising a second key decryption step, which comprises the following sub-steps:
entering a decryption command through the keyboard (6),
reading the NFC chip (4) that contains the previously stored private key/seed phrase to be decrypted,
displaying the unique identification code of the NFC chip on the screen (5),
confirming the download of the second cryptogram stored on the NFC chip (4) to the secure hardware element (21),
requesting the entry of the second decryption password of the second cryptogram, and entering it through the keyboard (6),
if the entered second password is correct, decrypting the second cryptogram by extracting all its contents into the secure hardware element (21), and launching a biometric authentication process of the authorized persons through identification of their biometric variables using biometric-variable readers (7),
validating the entered biometric variables by comparing them with the biometric variables extracted from the second cryptogram,
if the entered biometric variables are correct, requesting the entry of the first password through the screen (5),
reading the first password entered by the authorized person, and if it is correct, decrypting the first cryptogram, displaying the private key/seed phrase on the screen (5), for a limited time, and
once the display of the key on the screen (5) has finished after the limited time, securely deleting all information stored in any memory and in the secure hardware element.

5. Method for encryption of private keys/seed phrases of crypto assets wallets and storage on NFC chips according to claim 4, wherein the sub-steps of displaying the unique identification code of the NFC chip (4) on the screen (5) include displaying it in QR format.

6. Method for encryption of private keys/seed phrases of crypto assets wallets and storage on NFC chips according to claim 4 or 5, wherein the first and second passwords comprise a maximum of 40 characters and a minimum of 12, including numbers, uppercase, lowercase, and symbols, to achieve sufficient complexity, thus avoiding weaknesses in the password that could reduce the entropy of the resulting cryptogram.

7. Method for encryption of private keys/seed phrases of crypto assets wallets and storage on NFC chips according to any of claims 4 to 6, wherein the cryptogram encryption algorithm comprises at least a symmetric algorithm type AES-256.

8. Method for encryption of private keys/seed phrases of crypto assets wallets and storage on NFC chips according to any of claims 4 to 7, wherein the sub-step of entering the biometric signature of the authorized person or persons to perform key decryptions comprises:
entry of the biometric signature of a single person, or
entry of biometric signatures of several persons, with a maximum of six persons, allowing decryption with all of them, or with five, four, three, two or just one of them, as configured in its creation.

9. Method for encryption of private keys/seed phrases of crypto assets wallets and storage on NFC chips according to any of claims 4 to 8, wherein the sub-step of entering the biometric signature of the authorized person or persons to perform key decryptions comprises the entry of:
up to four fingerprints per authorized person, and a minimum of two,
up to two iris configurations per authorized person; the entry of only one biometric data per person being sufficient to access the first cryptogram,

10. Method for encryption of private keys/seed phrases of crypto assets wallets and storage on NFC chips according to any of claims 4 to 9, wherein the sub-step of recording the second cryptogram on the NFC chip (4) comprises the following steps:
requesting the user to bring the NFC chip (4) close to the NFC chip reader/writer (3),
verifying that the unique identification code of the NFC chip (4) is correct, proceeding with the recording in that case, and giving a warning otherwise.

11. Method for encryption of private keys/seed phrases of crypto assets wallets and storage on NFC chips according to any of claims 4 to 10, wherein the sub-step of recording the second cryptogram on the NFC chip (4) comprises a step of data deletion and restart of the process in the event of a second incorrect reading of the unique identification code of the NFC chip (4).

12. Method for encryption of private keys/seed phrases of crypto assets wallets and storage on NFC chips according to any of claims 4 to 11, wherein the sub-step of entering the second password comprises a step of data deletion and restart of the process in the event of a second incorrect entry, including the introduction of an incremental temporal delay for enabling new attempts on the NFC chip (4) with that unique identification code.

13. Method for encryption of private keys/seed phrases of crypto assets wallets and storage on NFC chips according to any of claims 4 to 12, wherein the sub-step of extracting the contents of the second cryptogram comprises storing the first cryptogram and extracted biometric variables in an area of the secure hardware element (21) with a different address from the general memory (22), where the rest of the contents of the second cryptogram will be stored.

14. Method for encryption of private keys/seed phrases of crypto assets wallets and storage on NFC chips according to any of claims 4 to 13, wherein the sub-step of validating the entered biometric variables with the biometric variables extracted from the second cryptogram comprises a step of secure data deletion and restart of the process in the event of any authentication failure; adding an access block to the first cryptogram stored in the secure hardware element (21) until a correct biometric reading is obtained solely from a biometric reader.

15. Method for encryption of private keys/seed phrases of crypto assets wallets and storage on NFC chips according to any of claims 4 to 14, wherein the sub-step of decrypting the first cryptogram comprises a step of secure data deletion and restart of the process in the event of incorrect entry of the first password.

16. Method for encryption of private keys/seed phrases of crypto assets wallets and storage on NFC chips according to any of claims 4 to 15, further comprising a step of cloning the information stored on the NFC chip (4), which comprises the following sub-steps:
entering the cloning command through the keyboard (6),
requesting the reading of the NFC chip (4) to be cloned, and displaying its unique identification code on the screen (5),
requesting the entry of the second password,
requesting biometric authentication of at least one of the authorized persons,
reading the required biometric variables and, if correct, downloading the second cryptogram into the secure hardware element (21),
requesting the approach to the reader/writer (3) of a blank destination NFC chip (4), displaying its unique identification code on the screen (5),
requesting confirmation from the authorized person for cloning onto the blank NFC chip (4) whose unique identification code has been displayed on the screen, and proceeding with the copy of the second cryptogram onto the blank NFC chip (4), and
deleting the second cryptogram from memory and the secure hardware element (21) once the copy has been made.

17. Method for encryption of private keys/seed phrases of crypto assets wallets and storage on NFC chips according to claim 16, wherein the sub-step of entering the second password comprises step of data deletion and restart of the process in the event of a second incorrect entry.
